(19) United States
(12) Patent Application Publication
(10) Pub. No.: US 2024/0405908 A1
(43) Pub. Date: Dec. 5, 2024

(54) TECHNIQUES FOR EFFICIENT TUNING OF MICRO-RING MODULATORS FOR WAVELENGTH DIVISION MULTIPLEXING

(71) Applicant: Lightmatter, Inc., Boston, MA (US)

(72) Inventors: Jessie Rosenberg, Bedford, MA (US); Anthony Kopa, Somerville, MA (US)

(73) Assignee: Lightmatter, Inc., Boston, MA (US)

(21) Appl. No.: 18/731,065

(22) Filed: May 31, 2024

Related U.S. Application Data
(60) Provisional application No. 63/505,480, filed on Jun. 1, 2023.

(51) Int. Cl. H04J 14/02

(52) U.S. Cl. CPC H04J 14/0204; H04J 14/0209; H04J 14/0221

(57) ABSTRACT

Techniques for efficiently tuning of optical resonant devices (e.g., micro-ring modulators (MRM) or add/drop filters) are described. The techniques described herein can be used in photonic communication systems that transmit data using several wavelengths of light sharing a common optical waveguide or a common fiber, e.g., wavelength division multiplexing (WDM) systems. These techniques may involve varying the way in which resonant wavelengths are mapped to the wavelengths of emission until it is determined that the power consumption is appropriate (e.g., below a certain threshold value). This significantly reduces the amount of power needed to ensure proper alignment between wavelength of emission and resonant wavelengths.

### CROSS-REFERENCE TO RELATED APPLICATIONS

This application claims the benefit under 35 U.S.C. § 119 (e) of U.S. Provisional Application Ser. No. 63/505,480, filed on Jun. 1, 2023, under Attorney Docket No. L0858.70073US00 and entitled “TECHNIQUES FOR EFFICIENT TUNING OF MICRO-RING MODULATORS FOR WAVELENGTH DIVISION MULTIPLEXING,” which is hereby incorporated herein by reference in its entirety.

### BACKGROUND

Photonic ring resonators are optical resonant devices that include a waveguide loop where light can circulate multiple times. They operate based on the principle of resonance, which allows them to selectively resonate with specific wavelengths of light. The basic structure of a ring resonator includes a circular or ring-shaped waveguide that is coupled to one or more linear waveguides.

Wavelength Division Multiplexing (WDM) is a technique used in fiber optic communications to multiplex multiple optical carrier signals on a single optical fiber by using different wavelengths of laser light to carry different signals. Photonic ring resonators play an important role in WDM due to their ability to manipulate specific wavelengths of light very precisely. This allows them to be used as filters that can add or drop specific wavelengths from the optical fiber or as modulators. In multiplexing, they can add specific wavelengths to a fiber, while in demultiplexing, they can extract specific wavelengths from the fiber without disturbing others.

For light to effectively resonate within a ring, its wavelength has to meet specific conditions related to the circumference of the ring: the optical path length of the ring generally has to be an integer multiple of the wavelength.

### BRIEF SUMMARY

Some embodiments relate to a method for controlling a plurality of optical resonant devices coupled to a light source configured to emit light at a plurality of wavelengths, the method comprising: applying a first biasing condition to the optical resonant devices resulting in each optical resonant device being aligned to a respective wavelength of the plurality of wavelengths in accordance with a first mapping; sensing an amount of power used in applying the first biasing condition; and if it is determined that the amount of power used in applying the first biasing condition is excessive, applying a second biasing condition to the optical resonant devices resulting in each optical resonant device being aligned to a respective wavelength of the plurality of wavelengths in accordance with a second mapping.

In some embodiments, applying the second biasing condition comprises shifting a resonant wavelength associated with a first optical resonant device of the plurality of optical resonant devices by an amount equal to a spacing between adjacent wavelengths of the plurality of wavelengths.

In some embodiments, shifting the resonant wavelength associated with the first optical resonant device comprises varying a current applied to a heater embedded in the first optical resonant device.

In some embodiments, determining that the amount of power is excessive comprises determining that the amount of power is higher than a threshold value.

In some embodiments, determining that the amount of power is excessive comprises determining that a local temperature of an optical resonant device is outside an allowed temperature range.

In some embodiments, sensing the amount of power used in applying the first biasing condition comprises sensing a current flowing through a heater.

In some embodiments, the method further comprises sensing an amount of power used in applying the second biasing condition; and if it is determined that the amount of power used in applying the second biasing condition is excessive, applying a third biasing condition to the optical resonant devices resulting in each optical resonant device being aligned to a respective wavelength of the plurality of wavelengths in accordance with a third mapping.

Some embodiments relate to an optical device comprising: a plurality of optical resonant devices optical coupled to a light source configured to emit light at a plurality of wavelengths; and a controller configured to apply a first biasing condition to the optical resonant devices resulting in each optical resonant device being aligned to a respective wavelength of the plurality of wavelengths in accordance with a first mapping; sense an amount of power used in applying the first biasing condition; and if it is determined that the amount of power used in applying the first biasing condition is excessive, apply a second biasing condition to the optical resonant devices resulting in each optical resonant device being aligned to a respective wavelength of the plurality of wavelengths in accordance with a second mapping.

In some embodiments, applying the second biasing condition comprises shifting a resonant wavelength associated with a first optical resonant device of the plurality of optical resonant devices by an amount equal to a spacing between adjacent wavelengths of the plurality of wavelengths.

In some embodiments, shifting the resonant wavelength associated with the first optical resonant device comprises varying a current applied to a heater embedded in the first optical resonant device.

In some embodiments, determining that the amount of power is excessive comprises determining that the amount of power is higher than a threshold value.

In some embodiments, determining that the amount of power is excessive comprises determining that a local temperature of an optical resonant device is outside an allowed temperature range.

In some embodiments, sensing the amount of power used in applying the first biasing condition comprises sensing a current flowing through a heater.

In some embodiments, the controller is further configured to sense an amount of power used in applying the second biasing condition; and if it is determined that the amount of power used in applying the second biasing condition is excessive, apply a third biasing condition to the optical resonant devices resulting in each optical resonant device being aligned to a respective wavelength of the plurality of wavelengths in accordance with a third mapping.

In some embodiments, the optical device further comprises a bus waveguide coupling the light source to the plurality of optical resonant devices.

In some embodiments, the optical resonant devices comprise optical ring resonators evanescently coupled to the bus waveguide.

Some embodiments relate to a method for controlling a plurality of optical resonant devices, comprising aligning the optical resonant devices to respective wavelengths of a plurality of wavelengths, wherein the aligning comprises mapping a first wavelength of the plurality of wavelengths to a first resonance associated with the plurality of optical resonant devices and mapping a second wavelength of the plurality of wavelengths to a second resonance associated with the plurality of optical resonant devices, wherein the first and second resonances are of different resonant orders.

In some embodiments, the plurality of optical resonant devices comprises micro-ring modulators (MRM).

In some embodiments, the plurality of optical resonant devices comprises resonant add/drop filters.

In some embodiments, the aligning further comprises shifting the first resonance by an amount equal to a spacing between adjacent wavelengths of the plurality of wavelengths.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1A a schematic diagram of a wavelength division multiplexing (WDM) system including a bank of optical resonant devices, in accordance with some embodiments.

FIG. 1B is a plot illustrating an exemplary mapping between resonators and wavelengths, in accordance with some embodiments.

FIG. 1C a schematic diagram of another WDM system including a bank of optical resonant devices, in accordance with some embodiments.

FIG. 1D a schematic diagram of another WDM system including a bank of optical higher order resonant devices, in accordance with some embodiments.

FIG. 2 illustrates the spectrum of the responses of the MRMs over a wider wavelength range, in accordance with some embodiments.

FIG. 3 also illustrates the spectrum of the responses of the MRMs, but with a different ring-wavelength mapping relative to FIG. 3, in accordance with some embodiments.

FIG. 4 is a diagram illustrating the global temperature of a chip alongside the local temperature of a resonant device, in accordance with some embodiments.

FIGS. 5A-5C is a biasing sequence associated with a bank of eight ring resonators, in accordance with some embodiments.

FIGS. 6A-6C is another biasing sequence associated with a bank of eight ring resonators, in accordance with some embodiments.

FIG. 7A is a flowchart illustrating a method for tuning a plurality of optical resonant devices, in accordance with some embodiments.

FIG. 7B-7C illustrate examples of a first biasing condition and a second biasing condition, in accordance with some embodiments.

FIG. 8 is a diagram providing a comparison between the local temperatures of a bank of MRMs at two distinct biasing conditions, in accordance with some embodiments.

### DETAILED DESCRIPTION

Described herein are techniques for efficiently tuning optical resonant devices (e.g., micro-ring modulators (MRM) or add/drop filters). The techniques described herein can be used in photonic communication systems that transmit data using several wavelengths of light sharing a common optical waveguide or a common fiber, e.g., wavelength division multiplexing (WDM) systems. MRMs are an attractive choice to encode the data in WDM systems because they are more compact than other types of modulators (e.g., Mach-Zehnder modulators). MRMs are described herein as examples of optical resonant devices. It should be noted, however, that the techniques described herein are not limited to use with MRMs, but can be applied to other types of optical resonant devices, including resonant add/drop filters and other types of filters, disk resonators, racetrack resonators, Fabry-Perot cavities, coupled ring reflectors (CRR) as well as other types of optical resonators that include two or more rings or disks coupled to each other.

Maintaining a constant wavelength in an on-chip photonic resonant device can be challenging due to several factors that influence the resonator's physical properties and its optical behavior. For example, photonic ring resonators are highly sensitive to temperature changes. Because the refractive index and the physical dimensions of the waveguide materials are temperature-dependent, even minor fluctuations in temperature can cause the resonant wavelength to shift. This is particularly problematic in densely packed electronic environments where heat generation is significant. To address these challenges, several techniques are employed, including active thermal stabilization. In active thermal stabilization techniques, individual resonators are thermally controlled. The inventors have recognized and appreciated that active thermal stabilization is costly from a power consumption standpoint, and have developed techniques for limiting power consumption.

Conventional active thermal stabilization uniquely maps resonant devices to wavelengths a priori. In other words, each WDM channel is uniquely assigned to a particular resonant device. This advantage of this approach is that it requires relatively simple control circuitry; however, it presents a major limitation. The amount of power required to uniquely map resonant devices to wavelengths in real time can be prohibitively large, especially when used in photonic circuits including hundreds of resonant devices.

The techniques developed by the inventors and described herein leverage the fact that a resonant devices has a periodic spectral response. Instead of uniquely mapping resonant devices to wavelengths a priori, the mapping is selected using a procedure designed to reduce power consumption. Thus, some embodiments include a sensor configured to monitor the power consumption associated with the tuning of resonant devices. A procedure is executed whereby a controller cycles through several resonator-wavelength mappings, until the controller selects a mapping that produces an appropriate level of power consumption. The periodic nature of the spectral response of resonant devices enables this procedure, as described in detail further below.

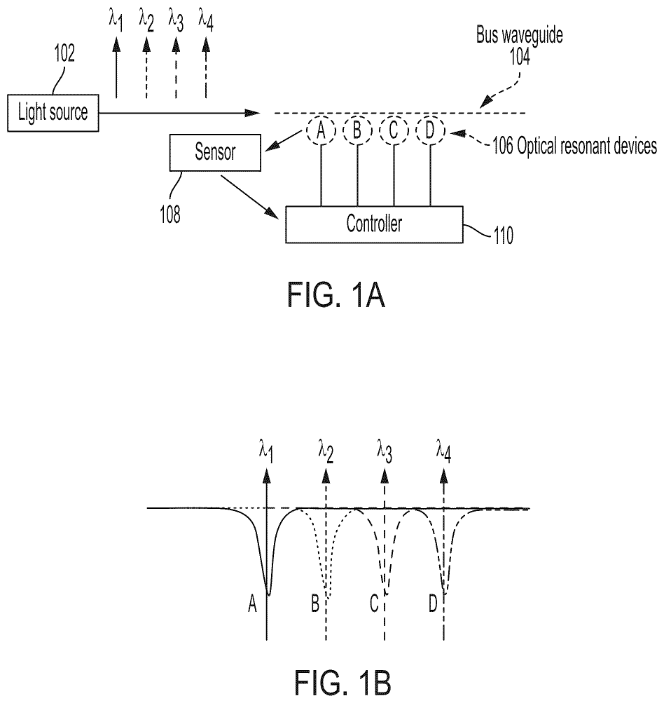

FIG. 1A is a schematic diagram of a WDM system including a light source 102, a bus waveguide 104, a bank of optical resonant devices 106, a sensor 108 and a controller 110. The resonant devices are implemented as micro-ring modulators (MRM) in this example, although other types of resonant devices are also possible, including disk resonators, racetrack resonators, and other types of devices that produce resonant spectral responses. Light source 102 produces light at various wavelengths (λ₁, λ₂, λ₃ and λ₄ in this example). In some embodiments, light source 102 may be formed on a separate substrate relative to the substrate hosting bus waveguide 104 and optical resonant devices 106. The substrates may be optically coupled to each other in various ways, for example using optical fibers. The produced wavelengths travel along bus waveguide 104, which may be evanescently coupled to a bank of MRMs. Each MRM (denoted by letters A, B, C, D) has a phase shifter embedded in the ring that is configured to coarsely tune the resonant wavelength of the ring over a large wavelength range. In some embodiments, the phase shifters may include heaters, in which phase shifting is enabled by the thermo-optic effect. Heating the ring allows for alignment of a ring to one of the wavelengths produced by the light source. As illustrated in FIG. 1B, MRM A is initially aligned to wavelength λ₁, MRM B to wavelength λ₂, MRM C to wavelength λ₃; and MRM D to wavelength λ₄. Controller 110 controls the phase shifters embedded in the rings, and consequently the spectral location of the resonant frequencies. As described in detail further below, sensor 108 monitors the power usage associated with the tuning of the rings by controller 110. Based on the input provided by sensor 108, controller 110 tunes the resonant wavelengths of the optical resonant devices according to the techniques described herein. Sensor 108 may be implemented in any of numerous ways, including for example as a thermopile, an infrared sensor such as a digital infrared thermometer or thermal imager, a semiconductor device exhibiting a temperature-dependent quantity (e.g., resistance or capacitance), a thermistor, an ammeter, a thermocouple, or other types of sensors.

FIG. 1C is a schematic diagram of another WDM system. As in FIG. 1A, this implementation includes a light source 102, a bus waveguide 104, a bank of optical resonant devices 106, a sensor 108 and a controller 110 (not shown in FIG. 1C). In addition, this implementation includes a bank channel waveguides 112 evanescently coupled to respective resonant devices. Evanescently coupling resonant devices between a common bus waveguide and a bank of channel waveguides 112 as shown in FIG. 1C allows the system to operate as an add/drop filter (in addition or in alternative to serving as a bank of modulators as in FIG. 1A). The techniques described herein can be applied to resonant devices configured to operate as modulators and/or as add/drop filters and/or as any other suitable type of device.

FIG. 1D is a schematic diagram of another WDM system to which techniques of the types described herein may be applied. The system of FIG. ID is similar to the system of FIG. 1C. The difference lies in the types of devices implementing optical resonant devices 106. The system of FIG. 1D uses CRRs. An CRR may be implemented using multiple rings (or disks) coupled to one another. The example of FIG. 1D illustrates CRRs having a pair of MRM. However, CRRs with more than two MRMs are also possible. The use of multiple coupled rings can enhance the reflectivity and wavelength selectivity compared to a single ring resonator. This makes CRRs more effective for precise optical filtering.

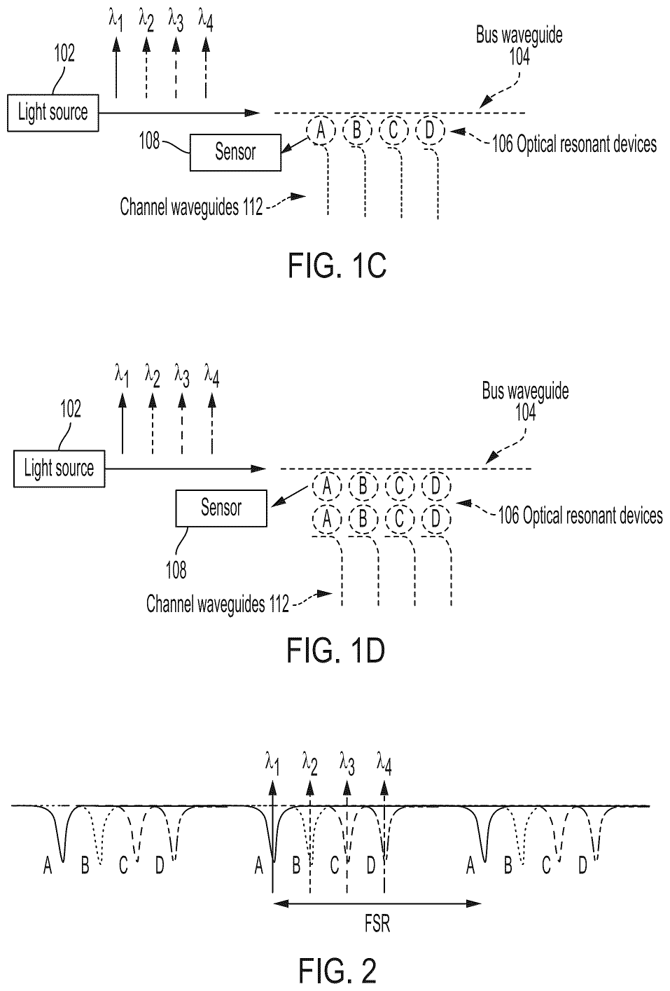

FIG. 2 illustrates the spectrum of the responses of the MRMs over a wider wavelength range relative to FIG. 1B. More specifically, FIG. 2 represents the spectrum as seen at the end of the bus waveguide 104, downstream from the resonant devices (in other words, the spectrum seen at the through port). As can be appreciated from FIG. 2, given the resonant nature of these devices, the pattern repeats itself and each repetition corresponds to a different resonant order of a ring. The order of an optical resonant device represents the number of resonances that the device can support. In the context of MRMs, for example, the order indicates the number of wavelengths that fit into the total optical path defined by one round trip of the MRM.

The periodicity of the repetition is defined as the free spectral range (FSR), a quantity that can be expressed in terms of nanometers of wavelength (or alternative, in gigahertz of frequency, given the relationship between wavelengths and frequencies). As in FIG. 1B, “A” represents the resonant response associate with MRM A of FIG. 1A, “B” represents the resonant response associate with MRM B of FIG. 1A, “C” represents the resonant response associate with MRM C of FIG. 1A, and “D” represents the resonant response associate with MRM D of FIG. 1A. As in FIG. 1B, MRM A is initially tuned to align to wavelength λ₁, MRM B to wavelength λ₂, MRM C to wavelength λ₃ and MRM D to wavelength λ₄.

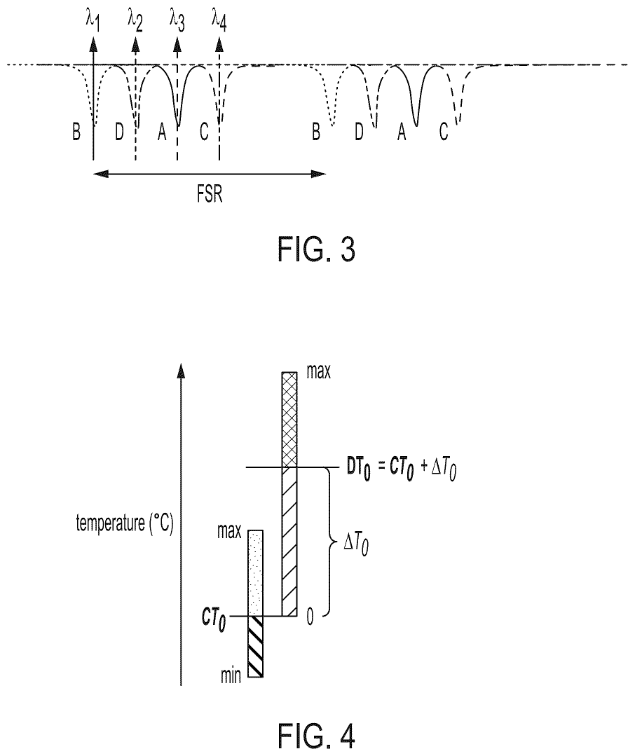

However, given the periodic nature of MRMs, there are other ways to map wavelengths to MRMs other than what is shown in FIG. 2. The labeling of the MRMs (A, B, C, D) may represent their physical placement in the chip. However, the inventors have recognized and appreciated that their order along the wavelength axis need not be the same. For example, the MRMs may be heated in such a way to arbitrarily reorder their spectra, for example as shown in FIG. 3. As described in detail further below, controller 110 may select the mapping (e.g., among that of FIG. 2, FIG. 3 and other possible mappings) that produces an appropriate level of power consumption.

As noted above, the MRMs can be coarsely tuned using heaters. The heaters may be controlled by controller 110 with the aid of sensor 108 to hold the local temperature of the respective MRM device constant, even as the global chip temperature fluctuates due to inevitable changes in environment. A heater holds the local temperature of the respective MRM in that it does not affect the temperature of another MRM. In other words, thermal crosstalk is negligible. Further, as long as these heated devices are not packed too densely, it is reasonable to assume that their heaters have no significant effect on the global chip temperature.

The global temperature of a chip should be distinguished from the local temperature of a particular device (e.g., an MRM) that is embedded in that chip. The global chip temperature may represent, for example, the average temperature of the entire chip. The global chip temperature may be measured using temperature sensors placed at a few strategic locations on the chip, such as near the edges or the center. The global temperature may be influenced by the overall power consumption of the chip, heat dissipation mechanisms (such as heat sinks and fans), and ambient conditions, and may affect the overall performance and reliability of the chip (e.g., high global temperature can lead to thermal stress and potential failure of the chip). The maximum global temperature represents the highest temperature rating for a particular chip-increasing the average chip temperature above this value is likely to affect the overall performance and reliability of the chip. By contrast, the local temperature of a device represents the temperature at a particular location on the chip (e.g., at or near the device). The local temperature can be significantly higher than the global temperature (e.g., due to localized heating from active optical components and nearby electrical circuits) without necessarily causing an increase in the global temperature of the chip. As described herein, the temperature of an optical resonant device may be adjusted using heaters.

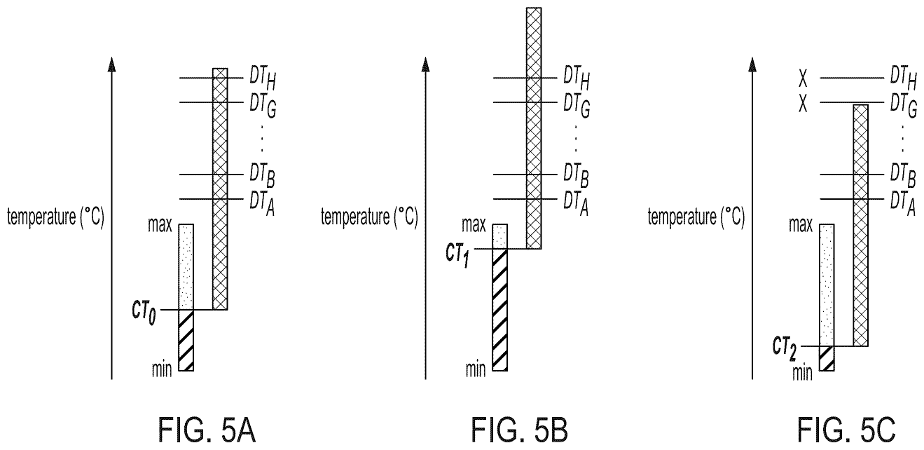

A heater may only increase temperature, not decrease it. Therefore, it may be desirable to bias the MRMs at local temperatures that are above the maximum allowed chip temperature (e.g., the highest global temperature rating), as discussed below in connection with FIG. 4. The MRM device and its heater are so small that its elevated local temperature decays away from the device thereby having a negligible effect on the temperature of other MRM devices of the system and the global temperature of the system (e.g., chip) as a whole.

FIG. 4 is a diagram illustrating the global temperature of a chip alongside the local temperature of a resonant device, in accordance with some embodiments. The bar on the left represents the global temperature of the chip (where “min” and “max” identify the minimum and maximum global temperatures allowed in the chip). CT₀ represents the present temperature of the chip. The bar on the right represents the additional temperature (relative to CT₀) of an MRM resulting from the use of a local heater. This bar ranges from 0 (where the temperature of the MRM equals the temperature of the chip) to a maximum value (above which the MRM is likely to experience permanent damage, e.g., due to electromigration). The present temperature of the MRM (DT₀) equals CT₀+ΔT₀, where ΔT₀ indicates the temperature increase effected by the local heater.

In the interest of limiting power consumption, it may be desirable to bias each MRM at a device temperature, DT, that minimizes the power dissipation in the heater for the most common operating global temperature scenario. In data center applications, for example, the most common global operating temperature is at or close to the maximum temperature allowed by the material (CTmax). Therefore, it may seem intuitive to operate the chip just slightly above CTmax. However, operating the chip in this manner presents some challenges.

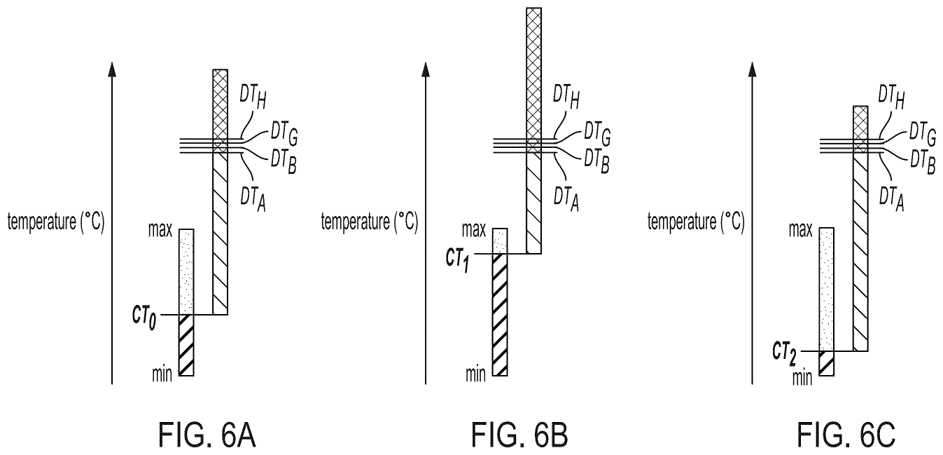

First, WDM dictates that the temperature of multiple MRMs—not just one—be simultaneously controlled. Tuning different MRMs to different wavelengths involves biasing each MRM at a different temperature. The sequence of FIG. 5A-5C illustrates what could happen as the chip temperature changes. At time to (FIG. 5A), the global temperature of CT₀ and a bias temperature within the allowed range is identified for each of eight MRMs (DT_{A}, DT_{B}, . . . DT_{H}). At time t1 (FIG. 5B), the global temperature of the chip increases to CT₁ while the controller continues to hold the temperature of each MRMs constant. However, at time t2 (FIG. 5C), the chip suddenly cools down (to CT₂) to the point where some MRMs cannot be held within the desired temperature range (namely, DT_{G} and DT_{H} are above the allowed range). This occurs because the feedback controller has a limited range of ΔT by which the MRM can be heated. This example illustrates that there is a tradeoff between range of chip temperature and ΔT. Increasing ΔT too much may lead to reduced reliability or even to permanent damage due to electromigration, and should generally be avoided.

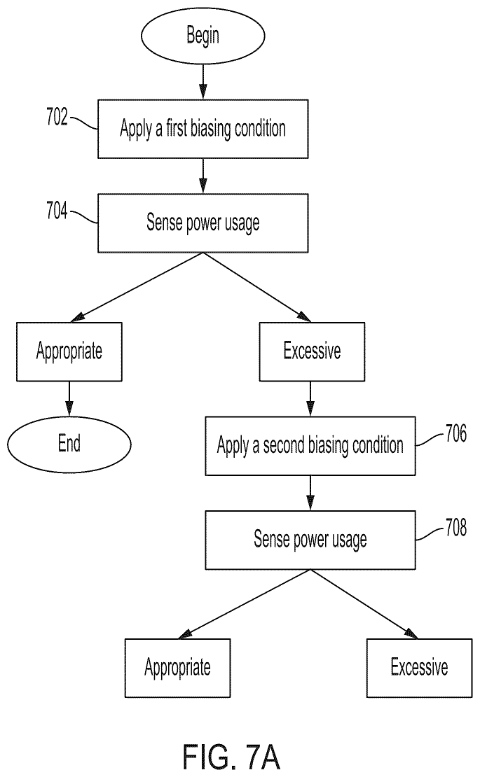

In the sequence illustrated in FIGS. 6A-6C, as the global temperature initially increases from CT₀ (FIG. 6A) to CT₁ (FIG. 6B) and then suddenly decreases from CT₁ to CT₂ (FIG. 6C), the feedback controller is able to maintain all the MRMs within the appropriate biasing temperatures. This greatly extends the usable range of chip temperatures while maintaining an acceptable ΔT range. The main difference between the sequence of FIGS. 5A-5C and the sequence of FIGS. 6A-6C is the extent of ΔT, which is smaller in FIGS. 6A-6C than it is in FIGS. 5A-5C.

Second, the MRMs are not identical to each other. In fact, their diameters may intentionally be made to be different from each other, so that the resonant wavelengths do not overlap with each other even in the unbiased state. An optical resonant device is said to be in the “unbiased state” when the voltage applied to the respective heater is equal to zero. If the relative diameters are chosen correctly, the MRMs can be tuned to the desired unique wavelengths while maintaining approximately the same temperature across all the MRMs. In practice, however, because of process variation, mismatch, and local temperature variation on chip, different temperature biases may be used. Processes variations and mismatches occur when the geometry of a device, once fabricated, slightly differs from the intended geometry. For example, an MRM may be designed to have a particular diameter (and as a result, to exhibit a particular resonant wavelength) but in practice, once fabricated, the diameter may be slightly different from the desired value.

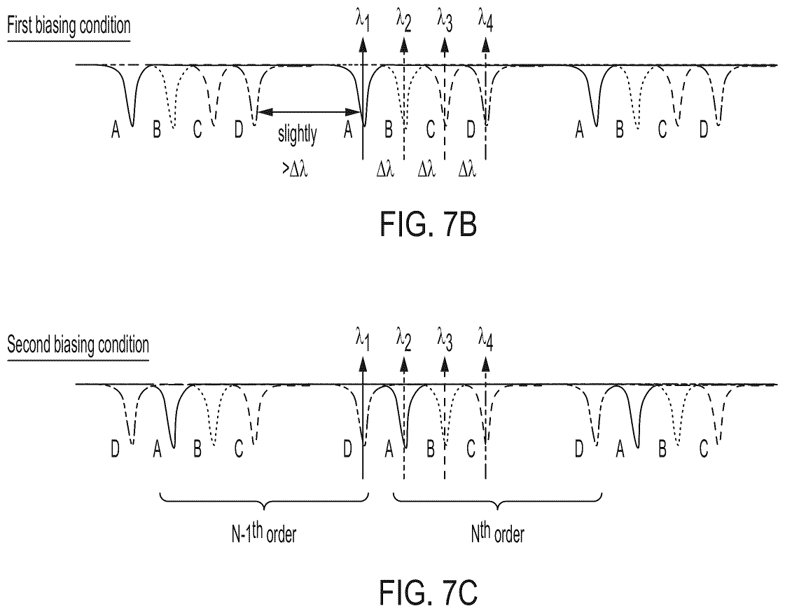

The inventors propose leveraging the periodic nature of the spectra of MRMs to bias the temperatures of all the MRMs in a more energy efficient way. A method for tuning the MRMs (or other types of resonant devices) to the wavelengths of the light source is described in connection with FIG. 7A.

At step 702, a controller applies a first biasing condition which assigns each MRM to a specific wavelength in accordance with a predefined mapping. This can be achieved by appropriately biasing the heater of each MRM until the resonant frequency of each MRM is aligned to the desired wavelength. At step 704, the power usage is monitored. For example, the controller may sense the amount of power expended to maintain biasing condition of step 702. Step 704 may involve using sensor 108 to sense the local temperature of each MRM and/or the current flowing through the heater, for example. If the controller determines that the power is excessive (e.g., is higher than a threshold value or it produces a temperature that is outside the allowed range), the method cycles through different ways to map MRMs to wavelengths. For example, the method may move to step 706, where the controller applies a second biasing condition which assigns each MRM to a wavelength in accordance with another mapping. The second biasing condition may be achieved by varying (e.g., decreasing) the current applied to one or more heaters relative to the first biasing condition. However, if the controller determines that the power is appropriate (e.g., is not excessive), the controller may maintain the resonators at the first biasing condition. At that point, the method may end. The method continues to cycle until the controller has identified a biasing condition that produces an appropriate level of power usage. For example, at step 708, the power usage used to maintain the system at the second biasing condition is monitored. The method proceeds in an iterative fashion until the controller has identified a biasing condition that produces an appropriate level of power usage. For example, if the controller determines at step 708 that the power is excessive, the method applies a third biasing condition (not shown in FIG. 7A). Otherwise, if the controller determines at step 708 that the power is appropriate, the controller may maintain the resonators at the second biasing condition. At that point, the method may end. Although FIG. 7A illustrates only two attempts at identifying the appropriate biasing condition, the method may cycle through several additional attempts.

Applying a biasing condition may involve applying a signal to a phase shifter embedded in an optical resonant device. The signal may be a direct current (DC) electric current in some embodiments. The magnitude of the signal to be applied to the phase shifter may be equal to the amount necessary to align the resonant wavelength of the resonant device to a particular target wavelength (e.g., λ₁). The phase shifter may be implemented in any of numerous ways, including for example of a heater embedded in the resonant device or a pn-junction.

FIG. 7B illustrates an example of a mapping resulting from the first biasing condition (as described in connection with step 702) and FIG. 7C illustrates an example of a mapping resulting from the second biasing condition (as described in connection with step 706). The first biasing condition results in a first mapping: the resonant frequency of MRM A is aligned to wavelength λ₁, the resonant frequency of MRM B is aligned to wavelength λ₂, the resonant frequency of MRM C is aligned to wavelength λ₃ and the resonant frequency of MRM D is aligned to wavelength λ₄. By contrast, the second biasing condition results in a second mapping: the resonant frequency of MRM A is aligned to wavelength λ₂, the resonant frequency of MRM B is aligned to wavelength λ₃, the resonant frequency of MRM C is aligned to wavelength λ₄ and the resonant frequency of MRM D is aligned to wavelength λ₁. Changing the biasing condition from the first to the second may involve shifting a resonant wavelength associated with an optical resonant device by an amount equal to a spacing between adjacent wavelengths of the plurality of wavelengths (indicated as Δλ in FIG. 7B). In some embodiments, this may be achieved by inducing a local temperature increase equal to ΔT, where ΔT may be approximately an integer multiple (N) of the temperature that leads the resonance of an MRM to shift by Δλ. Because the ΔT necessary to achieve a Δλ shift may not be known a priori, a feedback loop controller may be used to confirm whether that condition has been met. The inventors have recognized and appreciated that the periodic nature of the spectral response of resonant devices is what enables multiple ways to map resonators to wavelengths. This is because, as the method cycles through different mappings, it is not necessary to map wavelengths to resonances that are part of the same resonant order. The order of an optical resonant device represents the number of resonances that the device can support. In the context of MRMs, for example, the order indicates the number of wavelengths that fit into the total optical path defined by one round trip of the MRM. In the example of FIG. 7C. wavelengths λ₂, λ₃ and λ₄ are mapped to the resonances (A, B and C) of the same order (e.g., N), while wavelength λ₁ is mapped to a resonance (D) of a different order (e.g., N-1).

In some embodiments, the second biasing condition may be obtained from the first biasing by shifting all the resonant frequencies to a lower order (or higher order). Alternatively, in some embodiments, the second biasing condition may be obtained from the first biasing by shifting all the resonant frequencies to a lower order (or higher order) and, at the same time, by mapping a subset of the resonant wavelengths to resonances of a different order relative to the remaining resonant wavelengths. These schemes can also lead to a power reduction.

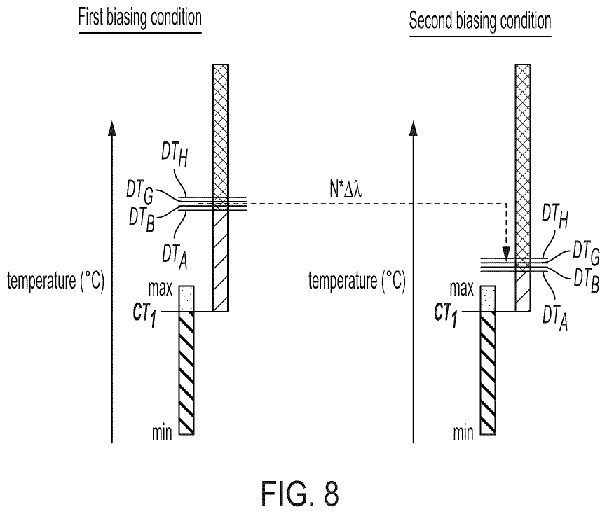

The impact is shown in FIG. 8, a diagram providing a comparison between the local temperatures on the MRMs at the two distinct biasing conditions discussed above in connection with FIGS. 7B-7C, in accordance with some embodiments. At the outset, it should be noted that the global temperature of the chip remained constant between the first and the second biasing condition. However, the local temperature of the resonant devices under the second biasing condition is substantially lower than the local temperature of the resonant devices under the first biasing condition. Thus, the amount of power expended to bias the resonant devices is reduced substantially as the method cycles from the first biasing condition to the second biasing condition.

A similar method may be used to align resonant filters (e.g., resonant add/drop filters of a WDM link, Fabry-Perot cavities, CRR or other suitable types of optical filters) to the desired wavelengths. In some embodiments, the cycling techniques described herein may be coordinated between MRMs and add/drop filters to achieve the desired objective. The desired objective may be, for example, to maximize the allowed temperature range of the chip, to minimize the total power consumption, or to match each MRM to a particular filter.

Accordingly, some embodiments relate to a method for controlling a plurality of optical resonant devices coupled to a light source configured to emit light at a plurality of wavelengths. The method may comprise applying a first biasing condition to the optical resonant devices resulting in each optical resonant device being aligned to a respective wavelength of the plurality of wavelengths in accordance with a first mapping. An example of the first mapping is shown in FIG. 7B.

Next, the method may comprise sensing an amount of power used in applying the first biasing condition. This can be achieved, for example, by sensing currents flowing through heaters embedded in the resonant devices and by inferring the power from the currents. Alternatively, this can be achieved by sensing the local temperature of the resonant devices and by inferring the power from the local temperature. If it is determined that the amount of power used in applying the first biasing condition is excessive, the method comprises applying a second biasing condition to the optical resonant devices resulting in each optical resonant device being aligned to a respective wavelength of the plurality of wavelengths in accordance with a second mapping. An example of the first mapping is shown in FIG. 7C. Under the second biasing condition, wavelengths may be mapped to resonances of different orders. In the depiction of FIG. 7C, for example, wavelength λ₁ is mapped to a resonance of a different order relative to that of wavelengths λ₂, λ₃ and λ₄.

Determining that the amount of power is excessive may comprise determining that the amount of power is higher than a threshold value. Alternatively, determining that the amount of power is excessive may comprise determining that a local temperature of an optical resonant device is outside an allowed temperature range.

However, if it is determined that the amount of power used in applying the first biasing condition is appropriate (e.g., not excessive), the first biasing condition is maintained.

The method may cycle until a mapping is identified where the amount of power used in applying that biasing condition is found to be appropriate. This may involve, for example, applying a third biasing condition resulting in a third mapping, applying a fourth biasing condition resulting in a fourth mapping, etc.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. For example, MRMs are provided as examples of optical resonant devices. It should be noted, however, that the techniques described herein are not limited to use with MRMs, but can be applied to other types of optical resonant devices, including resonant add/drop filters and other types of filters, disk resonators, racetrack resonators, coupled ring reflectors (CRR) as well as other types of higher order optical resonators that include two or more rings or disks coupled to each other.

In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within +20% of a target value in some embodiments, within +10% of a target value in some embodiments, within +5% of a target value in some embodiments, and yet within +2% of a target value in some embodiments. The terms “approximately” and “about” may include the target value.

What is claimed is:

1. A method for controlling a plurality of optical resonant devices coupled to a light source configured to emit light at a plurality of wavelengths, the method comprising:
applying a first biasing condition to the optical resonant devices resulting in each optical resonant device being aligned to a respective wavelength of the plurality of wavelengths in accordance with a first mapping;
sensing an amount of power used in applying the first biasing condition; and
if it is determined that the amount of power used in applying the first biasing condition is excessive, applying a second biasing condition to the optical resonant devices resulting in each optical resonant device being aligned to a respective wavelength of the plurality of wavelengths in accordance with a second mapping.

2. The method of claim 1, wherein applying the second biasing condition comprises shifting a resonant wavelength associated with a first optical resonant device of the plurality of optical resonant devices by an amount equal to a spacing between adjacent wavelengths of the plurality of wavelengths.

3. The method of claim 2, wherein shifting the resonant wavelength associated with the first optical resonant device comprises varying a current applied to a heater embedded in the first optical resonant device.

4. The method of claim 1, wherein determining that the amount of power is excessive comprises determining that the amount of power is higher than a threshold value.

5. The method of claim 1, wherein determining that the amount of power is excessive comprises determining that a local temperature of an optical resonant device is outside an allowed temperature range.

6. The method of claim 1, wherein sensing the amount of power used in applying the first biasing condition comprises sensing a current flowing through a heater.

7. The method of claim 1, further comprising:
sensing an amount of power used in applying the second biasing condition; and
if it is determined that the amount of power used in applying the second biasing condition is excessive, applying a third biasing condition to the optical resonant devices resulting in each optical resonant device being aligned to a respective wavelength of the plurality of wavelengths in accordance with a third mapping.

8. An optical system comprising:
a plurality of optical resonant devices optically coupled to a light source configured to emit light at a plurality of wavelengths; and
a controller configured to:
apply a first biasing condition to the optical resonant devices resulting in each optical resonant device being aligned to a respective wavelength of the plurality of wavelengths in accordance with a first mapping;
sense an amount of power used in applying the first biasing condition; and
if it is determined that the amount of power used in applying the first biasing condition is excessive, apply a second biasing condition to the optical resonant devices resulting in each optical resonant device being aligned to a respective wavelength of the plurality of wavelengths in accordance with a second mapping.

9. The optical system of claim 8, wherein applying the second biasing condition comprises shifting a resonant wavelength associated with a first optical resonant device of the plurality of optical resonant devices by an amount equal to a spacing between adjacent wavelengths of the plurality of wavelengths.

10. The optical system of claim 9, wherein shifting the resonant wavelength associated with the first optical resonant device comprises varying a current applied to a heater embedded in the first optical resonant device.

11. The optical system of claim 8, wherein determining that the amount of power is excessive comprises determining that the amount of power is higher than a threshold value.

12. The optical system of claim 8, wherein determining that the amount of power is excessive comprises determining that a local temperature of an optical resonant device is outside an allowed temperature range.

13. The optical system of claim 8, wherein sensing the amount of power used in applying the first biasing condition comprises sensing a current flowing through a heater.

14. The optical system of claim 8, wherein the controller is further configured to:
sense an amount of power used in applying the second biasing condition; and
if it is determined that the amount of power used in applying the second biasing condition is excessive, apply a third biasing condition to the optical resonant devices resulting in each optical resonant device being aligned to a respective wavelength of the plurality of wavelengths in accordance with a third mapping.

15. The optical system of claim 8, further comprising a bus waveguide coupling the light source to the plurality of optical resonant devices.

16. The optical system of claim 15, wherein the optical resonant devices comprise optical ring resonators evanescently coupled to the bus waveguide.

17. A method for controlling a plurality of optical resonant devices, comprising:
aligning the optical resonant devices to respective wavelengths of a plurality of wavelengths, wherein the aligning comprises mapping a first wavelength of the plurality of wavelengths to a first resonance associated with the plurality of optical resonant devices and mapping a second wavelength of the plurality of wavelengths to a second resonance associated with the plurality of optical resonant devices, wherein the first and second resonances are of different resonant orders.

18. The method of claim 17, wherein the plurality of optical resonant devices comprises micro-ring modulators (MRM).

19. The method of claim 17. wherein the plurality of optical resonant devices comprises resonant add/drop filters.

20. The method of claim 17. wherein the aligning further comprises shifting the first resonance by an amount equal to a spacing between adjacent wavelengths of the plurality of wavelengths.
